(19) United States
(12) Patent Application Publication
(10) Pub. No.: US 2013/0035432 A1
(43) Pub. Date: Feb. 7, 2013

(54) PROCESS FOR THE PRODUCTION OF PHYLLOSILICATE DISCS HAVING A HIGH ASPECT RATIO

(71) Applicants: Josef Breu, Bayreuth (DE); Michael Möller, Bayreuth (DE); Hussein Kalo, Bayreuth (DE); Arno Nennemann, Bergisch Gladbach (DE)

(72) Inventors: Josef Breu, Bayreuth (DE); Michael Möller, Bayreuth (DE); Hussein Kalo, Bayreuth (DE); Arno Nennemann, Bergisch Gladbach (DE)

(73) Assignee: Bayer Intellectual Property GmbH, Monheim (DE)

(21) Appl. No.: 13/574,194

(22) PCT Filed: Jan. 17, 2011
(86) PCT No.: PCT/EP2011/050521

§ 371 Date: Oct. 15, 2012

(30) Foreign Application Priority Data
Jan. 20, 2010 (EP) 10000512.3

(51) Int. Cl. C09K 21/02; C09K 3/00; C08K 3/34

(52) U.S. Cl. 524/443; 252/601; 252/182.32; 252/182.33

(57) ABSTRACT

The present invention relates to a process for the production of phyllosilicate platelets having a high aspect ratio, to a phyllosilicate platelet obtainable by the process according to the invention, to the use of phyllosilicate platelets according to the invention in the production of a composite material, of a flameproof barrier or of a diffusion harrier, and to a composite material comprising or obtainable using phyllosilicate platelets according to the invention.

The present invention relates to a process for the production of phyllosilicate platelets having a high aspect ratio, to a phyllosilicate platelet obtainable by the process according to the invention, to the use of phyllosilicate platelets according to the invention in the production of a composite material, of a flameproof barrier or of a diffusion barrier, and to a composite material comprising or obtainable using phyllosilicate platelets according to the invention.

It is known in the prior art to add phyllosilicates to surface-coating compositions or composite materials. The mechanical properties of the resulting systems can be improved thereby. In particular, it is possible in that manner to increase the barrier action of a surface-coating or composite material layer.

It has been shown that the degree of improvement in the properties depends significantly on the aspect ratio of the platelets forming the phyllosilicate. It is accordingly desirable in principle to produce phyllosilicate platelets having a high aspect ratio, because it is possible to obtain therewith surface-coating or composite material layers which are distinguished by particularly good mechanical properties and a high barrier action.

The aspect ratio is understood as being the quotient of the platelet length and the height of the platelet. Consequently, both an increase in the platelet length and a reduction in the platelet height brings about an increase in the aspect ratio. The theoretical lower limit of the platelet height of phyllosilicates is a single silicate lamella, which in the case of 2:1 phyllosilicates amounts to about one nanometre.

In general, phyllosilicates have stacks of silicate lamellae, so-called tactoids, with heights of from several nanometres to a few millimetres. The platelet diameters in the case of phyllosilicates, depending on their composition and formation, are from a few nanometres (hydrothermally produced smectites) to several centimetres (micas). Natural phyllosilicates therefore have aspect ratios of from 20 to about 400.

The aspect ratio can subsequently be increased within certain limits by chemical and/or physical treatment, by cleaving (exfoliating) the platelets along their stack axis. However, an increase in the platelet lengths is possible only by varying the synthesis conditions.

The increase in the aspect ratio which accompanies the exfoliation is regarded, for example, as being an important condition for the production of polymer-phyllosilicate nanocomposites having improved properties (H. A. Stretz, D. R. Paul, R. Li, H. Keskkula, P. E. Cassidy, Polymer 2005, 46, 2621-2637 and L. A. Utracki, M. Sepehr, E. Boccaleri, Polymers for Advanced Technologies 2007, 18, 1-37). For an explanation of the term exfoliation, or delamination, reference is made to G. Lagaly, J. E. F. C. Gardolinsky, Clay Miner. 2005, 547-556. Intercalatable and exfoliatable phyllosilicates are, for example, montmorillonites or hectorites from the class of the smectites.

A disadvantage in the processing of hitherto known phyllosilicates is their in some cases contradictory properties. For example, it is known that hydrothermally produced smectites (e.g. Optigel SH) exhibit extremely good swelling behaviour, as a result of which spontaneous exfoliation into individual silicate lamellae (delamination) is achieved. However, such smectites have small platelet diameters of about 50 nanometres, so that the aspect ratios do not exceed a value of 50.

Although natural phyllosilicates of the montmorillonite or vermiculite type exhibit platelet diameters of from several hundred nanometres to a few micrometres, spontaneous delamination does not occur. However, the aspect ratio can be increased by complex exfoliation steps.

Phyllosilicates of the mica type exhibit platelet lengths of several centimetres, but exfoliation is not possible owing to the strong interlamellar forces, so that the enormous platelet height cannot be reduced efficiently.

The synthetic production of phyllosilicates is described, for example, in J. T. Kloprogge, S. Komarneni, J. E. Arnonette, Clays Clay Miner. 1999, 47 529-554. Synthetic phyllosilicates have hitherto been used analogously to the naturally occurring phyllosilicates, that is to say they are modified chemically in order to obtain phyllosilicate platelets which are intercalated or exfoliated to the greatest possible extent (L. T. J. Korley, S. M. Liff, N. Kumar, G. H. McKinley, P. T. Hammond, Macromolecules 2006, 39 7030-7036).

The synthesis of a swellable phyllosilicate of the taeniolite type is known from U.S. Pat. No. 4,045,241. This material is produced by means of a process which lasts several hours and has a high outlay in terms of energy. A general disadvantage found was a massive loss of volatile binary fluorides. This mass loss must be compensated for by a drastically increased addition of fluorides in the initial weighed amount.

In the as yet unpublished PCT application having application number PCT/EP2009/006560, a process for the production of non-swellable phyllosilicate tactoids of medium layer charge is described. Synthetic smectites having a layer charge in the range from 0.2 to 0.8 are thereby obtained in a first step.

The object of the present invention was to provide a process for the production of phyllosilicate platelets having a high aspect ratio.

This object is achieved by a process in which
A) a synthetic smectite of the formula

[M_{n/valency}]^{inter} [M^{I}ₘM^{II}ₒ]^{oct} [M^{III}₄]^{tet} X₁₀Y₂
in which
M are metal cations of oxidation state 1 to 3,
M^{I} are Metal cations of oxidation state 2 or 3,
M^{II} are metal cations of oxidation state 1 or 2,
M^{III} are atoms of oxidation state 4,
X are di-anions and
Y are mono-anions,
m for metal atoms M^{I} of oxidation state 3 is ≦2.0 and for metal atoms M^{I} of oxidation state 2 is ≦3.0,
o is ≦1.0 and
the layer charge n is >0.8 and ≦1.0,
is prepared by high-temperature melt synthesis and
B) the synthetic smectite of step A) is exfoliated and/or delaminated to give phyllosilicate platelets having a high aspect ratio.

By means of the process according to the invention it is possible to obtain phyllosilicate platelets having an average aspect ratio greater than 400.

A further advantage of the phyllosilicate platelets obtainable by the process according to the invention is that, unlike natural montmorillonites and vermiculites, which are more or less yellowish-brown in colour, they are colourless. This allows colourless composite materials to be produced therefrom.

M preferably has oxidation state 1 or 2. M is particularly preferably Li⁺, Na⁺, Mg²⁺. or a mixture of two or more of those ions. M is most particularly preferably Li⁺.

M^{I} is preferably Mg²⁺, Al³⁺, Fe²⁺, Fe³⁺ or a mixture of two or more of those ions.

M^{II} is preferably Li⁺, Mg²⁺ or a mixture of those cations.

M^{III} is preferably a tetravalent silicon cation.

X is preferably O²⁻.

Y is preferably OH⁻ or F⁻, particularly preferably F⁻.

The layer charge n is preferably ≧0.85 and ≦0.95.

According to a particularly preferred embodiment of the invention, M is Li⁺, Na⁺, Mg²⁺ or a mixture of two or more of those ions, M^{I} is Mg²⁺, Al³⁺, Fe²⁺, Fe³⁺ or a mixture of two or more of those ions, M^{II} is Li⁺, Mg²⁺ or a mixture of those ions, M^{III} is a tetravalent silicon cation, X is O²⁻ and Y is OH⁻ or F⁻.

The synthetic smectites of the formula [M_{n/valency}]^{inter} [M^{I}ₘM^{II}ₒ]^{oct} [M^{III}₄]^{tet} X₁₀Y₂ can be prepared by heating compounds of the desired metals (salts, oxides, glasses) in the stoichiometric ratio in an open or closed crucible system to form a homogeneous melt and, then cooling the melt again.

In the case of synthesis in a closed crucible system there can be used as starting compounds alkali salts/alkaline earth salts, alkaline earth oxides and silicon oxides, preferably binary alkali fluorides/alkaline earth fluorides, alkaline earth oxides and silicon oxides, particularly preferably LiF, NaF,MgF₂, MgO, quartz.

The relative proportions of the starting compounds are then, for example, from 0.4 to 0.6 mol of F⁻ in the form of the alkali/alkaline earth fluorides per mol of silicon dioxide and from 0.4 to 0.6 mol of alkaline earth oxide per mol of silicon dioxide, preferably from 0.45 to 0.55 mol of F⁻ in the form of the alkali/alkaline earth fluorides per mol of silicon dioxide and from 0.45 to 0.55 mol of alkaline earth oxide per mol of silicon dioxide, particularly preferably 0.5 mol of F⁻ in the form of the alkali/alkaline earth fluorides per mol of silicon dioxide and 0.5 mol of alkaline earth oxide per mol of silicon dioxide.

Charging of the crucible is preferably carried out in such a manner that first the more volatile substances, then the alkaline earth oxide and finally the silicon oxide are weighed in.

Typically, a high-melting crucible made of a metal that is chemically inert or slow to react, preferably of molybdenum or platinum, is used.

Before it is closed, the charged, still open crucible is preferably heated in vacuo at temperatures of from 200° C. to 1100° C., preferably from 400 to 900° C., in order to remove residual water and volatile impurities. Experimentally, the procedure is preferably such that the upper crucible edge is red-hot while the lower region of the crucible has lower temperatures.

A presynthesis is optionally carried out in the closed pressure-resistant crucible for from 5 to 20 minutes at from 1700 to 1900° C., particularly preferably at from 1750 to 1850° C., in order to homogenise the reaction mixture.

The heating and the presynthesis are typically carried out in a high-frequency induction furnace. The crucible is protected from oxidation by a protecting atmosphere (e.g. argon), reduced pressure or a combination of both measures.

The main synthesis is carried out with a temperature programme that is adapted to the material. This synthesis step is preferably carried out in a rotary graphite furnace with horizontal orientation of the axis of rotation. In a first heating step, the temperature is increased from room temperature to from 1600 to 1900° C., preferably from 1700 to 1800° C., at a heating rate of from 1 to 50° C./minute, preferably from 10 to 20° C./minute. In a second step, heating is carried out at from 1600 to 1900° C., preferably from 1700 to 1800° C. The heating phase of the second step lasts preferably from 10 to 240 minutes, particularly preferably from 30 to 120 minutes. In a third step, the temperature is lowered to a value of from 1100 to 1500° C., preferably from 1200 to 1400° C., at a cooling rate of from 10 to 100° C./minute, preferably from 30 to 80° C./minute. In a fourth step, the temperature is lowered to a value of from 1200 to 900° C., preferably from 1100 to 1000° C., at a cooling rate of from 0.5 to 30° C./minute, preferably from 1 to 20° C./minute. The reduction in the heating rate after the fourth step to room temperature takes place, for example, at a rate of from 0.1 to 100° C./minute, preferably in an uncontrolled manner by switching off the furnace.

The procedure is typically carried out under protecting gas such as, for example, Ar or N₂.

The phyllosilicate is obtained in the form of a crystalline, hygroscopic solid after the crucible has been broken open.

In the case of synthesis in an open crucible system, there is preferably used a glass stage of the general composition wSiO₂.xM^{a}.yM^{b}.zM^{c}, wherein 5<w<7; 0<x<4; 0≦y<2; 0≦z <1.5 and M^{a}, M^{b}, M^{c} are metal oxides and M^{a} is other than M^{b} is other than M^{c}.

M^{a}, M^{b}, M^{c} independently of one another can be metal oxides, preferably Li₂O, Na₂O, K₂O, Rb₂O, MgO, particularly preferably Li₂O, Na₂O, MgO. M^{a} is other than M^{b} is other than M^{c}.

The glass stage is prepared in the desired stoichiometry from the desired salts, preferably the carbonates, particularly preferably Li₂CO₃, Na₂CO₃, and a silicon source such as, for example, silicon oxides, preferably silica. The pulverulent constituents are converted into a glassy state by heating and rapid cooling. The conversion is carried out preferably at from 900 to 1500° C., particularly preferably at from 1000 to 1300° C. The heating phase in the preparation of the glass stage lasts from 10 to 360 minutes, preferably from 30 to 120 minutes, particularly preferably from 40 to 90 minutes. This procedure is typically carried out in a glassy carbon crucible under a protected atmosphere and/or reduced pressure by means of high-frequency induction heating. The reduction of the temperature to room temperature is carried out by switching off the furnace. The resulting glass stage is then finely ground, which can be carried out, for example, by means of a powder mill.

Further reactants are added to the glass stage in a weight ratio of from 10:1 to 1:10 in order to achieve the stoichiometry in A). Ratios of from 5:1 to 1:5 are preferred. If necessary, an excess of the readily volatile additives of up to 10% can be added. These are, for example, alkali or alkaline earth compounds and/or silicon compounds. Preference is given to the use of light alkali and/or alkaline earth fluorides as well as the carbonates and oxides thereof, as well as silicon oxides. Particular preference is given to the use of NaF, MgF₂, LiF and/or an annealed mixture of MgCO₃Mg(OH)₂ and silica.

The mixture is then heated above the melting temperature of the eutectic of the compounds used, preferably to from 900 to 1500° C., particularly preferably to from 1100 to 1400° C. The heating phase lasts preferably from 1 to 240 minutes, particularly preferably from 5 to 30 minutes. Heating is carried out at a heating rate of from 50 to 500° C./minute, preferably at the maximum possible heating rate of the furnace. Cooling after the heating phase to room temperature is carried out at a rate of from 1 to 500° C./minute, preferably in an uncontrolled manner by switching off the furnace. The product is obtained in the form of a crystalline, hygroscopic solid.

The synthesis is typically carried out in a glassy carbon crucible under an inert atmosphere. Heating is typically carried out by high-frequency induction.

The described process is substantially more economical owing to the energy-efficient heating by high-frequency induction, the use of inexpensive starting compounds (a high degree of purity is not required, predrying of the starting materials is not required, broader range of starting materials such as, for example, advantageous carbonates) and a greatly shortened synthesis time as compared with synthesis in a closed crucible system and the possibility of multiple use of the crucible. High-temperature melt synthesis in an open crucible system is therefore particularly preferred.

After the synthesis, the synthetic phyllosilicate can preferably be freed of soluble synthesis products. This can be carried out by means of washing with polar solvents, preferably with aqueous or water-soluble solvents, particularly preferably with water, dilute acids or lyes, methanol or mixtures thereof. The washing operation is preferably carried out by means of dialysis, centrifugation or filtration.

In step B), the synthetic smectite can preferably be introduced into a polar solvent in order to exfoliate and/or delaminate it.

It is particularly preferred if water, water-miscible solvents, dilute aqueous acids or bases and/or mixtures thereof are used as the polar solvent in step B).

After incorporation into polar solvents, the synthetic smectite exhibits swelling. The swelling takes place without further chemical treatment of the smectite. Exfoliation or delamination occurs as a result of the swelling.

In that manner, dispersions of the phyllosilicate platelets in polar solvents can also readily be prepared. The invention likewise provides such dispersions.

Although chemical or physical treatment is not necessary for the exfoliation, such treatment can assist, accelerate or further promote exfoliation. Preference is given to physical dispersion with high shear forces, particularly preferably by means of a rotor-stator disperser, a multi-roll mill, a ball mill, ultrasonic or high-pressure jet dispersion.

The invention further provides a phyllosilicate platelet obtainable by the process according to the invention.

The invention likewise provides the use of phyllosilicate platelets according to the invention in the production of a composite material, a flameproof barrier or a diffusion barrier.

For example, a dispersion of the phyllosilicate platelets in a polar solvent such as water can be used to apply a flameproof or diffusion barrier to a substrate. To that end, the dispersion can be applied to the substrate and then the solvent can be removed, for example by drying.

The invention further provides a composite material comprising or obtainable using phyllosilicate platelets according to the invention.

It is particularly preferred if the composite material contains a polymer.

In order to produce polymer composites, the phyllosilicate platelets can in particular be incorporated into any conventional polymers which have been produced by polycondensation, polyaddition, radical polymerisation, ionic polymerisation and copolymerisation. Examples of such polymers are polyurethanes, polycarbonate, polyamide, PMMA, polyesters, polyolefins, rubber, polysiloxanes, EVOH, polylactides, polystyrene, PEO, PPO, PAN, polyepoxides.

Incorporation into polymers can be carried out by means of conventional techniques such as, for example, extrusion, kneading processes, rotor-stator processes (Dispermat, Ultra-Turrax, etc.), grinding processes (ball mill, etc.) or jet dispersion and is dependent on the viscosity of the polymers.

### EXAMPLES

The invention is explained in detail in the following by means of examples.

### Methods:

Oxygen barrier: The determination of the oxygen barrier was carried out in accordance with DIN 53380, Part 3, using a measuring device from Modern Controls, Inc. at a temperature of 23° C. with pure oxygen (99.95%). The relative humidity of the measuring and carrier gas was 50%.

X-ray diffraction: The d(001) values were measured by measuring the phyllosilicate samples using a Panalytical XPERT-Pro powder diffractometer (Cu anode, nickel filter, Cu—Kα: 1.54187 Å) with Bragg-Brentano geometry.

Inductively Coupled Plasma Atom Emission Spectroscopy (ICP-AES): Quantitative elemental analysis by ICP-AES was carried out using a JY 24 spectrometer (Jobin Yvon).

Atom Absorption Spectroscopy (AAS): Quantitative elemental analysis of the chemically opened phyllosilicate samples (use of a conventional standard procedure) by AAS was carried out using a Varian AA100.

Atomic force microscopy (AFM): The imaging of particles under the AFM was carried out using a MFP3D™ AFM (Asylum Research) with silicon cantilever (k_{c}: 46 Nm⁻).

Scanning electron microscopy (SEM): Investigations by scanning electron microscopy were carried out using a LEO 1530 FESEM with field emission cathode.

Laser diffraction: The particle size distribution of the aqueous dispersions was measured by laser diffraction using a Horiba LA 950 particle analyser (Retsch GmbH).

Conductivity: The electrical conductivity of the aqueous wash solutions was measured at RT using a HI 99300 mobile conductometer (Hanna Instruments).

### Materials:

Self-adhesive polypropylene film, No. 7005, thickness about 63 μm. HERMA GmbH, Fabrikstralβe 16, 70794 Filderstadt, Germany

Cloisite Na+; Sodium montmorillonite, Southern Clay Products Inc., 1212 Church Street, Gonzales, Tex. 78629, USA.

Optigel SH; Hectorite from hydrothermal synthesis, formerly: Süd Chemie AG, Ostenrieder Str. 15, 85368 Moosburg; now: Rockwood Clay Additives GmbH, Stadtwaldstr. 44, 85368 Moosburg, Germany.

Li₂CO₃; >99%; Merck Eurolab GmbH, John-Deere-Str. 5, 76646 Bruchsal.

Silica (SiO₂×nH₂O)); >99.5%; Sigma-Aldrich Chemie GmbH, Eschenstr. 5; 82024 Tautkirchen.

MgCO₃Mg(OH)₂; extra pure; Fischer Scientific GmbH, lm Heiligen Feld 17; 58239 Schwerte.

LiF; >99%; Merck Eurolab GmbH, John-Deere-Str. 5, 76646 Bruchsal.

MRF₂; >99.5%; Alfa Aesar GmbH & Co KG, Zeppelinstrasse 7, 76185 Karlsruhe.

### Example 1

### Preparation of A (Li_{0.9} Hectorite)

The synthesis of the Li hectorite of planned composition [Li_{0.9}]^{inter} [Mg_{2.1}Li_{0.9}]^{oct} [Si₄]^{tet} O₁₀F₂ is carried out via an amorphous alkali glass (called: precursor α) having the composition Li₂O.2SiO2. This glass is prepared by finely mixing the salts LiCO₃ (13.83 g) and silica (SiO₂×nH₂O; 24.61 g) and inductively heating the mixture for 1 hour at 1150° C., under argon, in a glassy carbon crucible.

In parallel, a second precursor (called: precursor β) is prepared by finely mixing MgCO₃Mg(OH)₂ (7.52 g) and silica (SiO₂×nH₂O; 10.47 g) and heating the mixture for 1 hour at 900° C. in an aluminium oxide crucible in a chamber furnace.

After cooling, 28.09 g of precursor a and the total amount of precursor β are pulverised and finely mixed with 12.50 g of MgF₂. The mixture is heated within a period of 5 minutes to 1300° C. by inductive heating in an open glassy carbon crucible under argon and left at that temperature for 8 minutes. After this step, the temperature is lowered to RT by switching off the furnace.

The strongly hygroscopic phyllosilicate is obtained in the form of a colourless or grey-tinged solid of low hardness, which crumbles after standing in air for only a short time. In water, a dispersion forms which settles out very slowly and contains a large proportion of a colloidal phase, which scarcely exhibits any settlement.

Identification: d(001)=12.2 Å (at 40% relative humidity). In measurements of aqueous pastes (3 parts by weight water:1 part by weight solid), a reflex occurs at about 70 Å, which indicates a high degree of osmotic swelling.

The composition (from 1CP-AES and AAS measurements) is [Li_{0.85}]^{inter} [Mg_{2.15}Li_{0.85}]^{oct} [Si₄]^{tet} O₁₀F₂.

In scanning electron microscope (SEM) images of aqueous Li hectorite dispersions which were dried slowly in air, phyllosilicate tactoids are scarcely discernible. Instead, a film of homogeneous appearance which adapts flexibly to the substrate surface is present.

Because of the higher z resolution (resolution of the sample height), the phyllosilicate platelets can successfully be imaged under the atomic force microscope (AFM). Flexible lamellae with lateral dimensions of up to 20 μm and a lamella height of 1 nm (aspect ratio: 20,000) can be seen. In some cases, stacks of several lamellae (fewer than 5) are also present.

A median value of the particle size of 29.3 μm was determined by laser diffraction.

### Example 2

### Barrier Properties of a Film of Li Hectorite

After the synthesis, the Li hectorite from Example 1 is added to demineralised water (about 20 g/l) and the soluble impurities of the synthesis are removed by dialysis against demineralised water (dialysis membrane of pore diameter 25-30 Å). The wash water of the dialysis is renewed several times until the conductivity no longer exceeds a value of 30 μS. The washed hectorite is freeze dried. A dispersion having a concentration of 3.4 g/1 is prepared from the dry Li hectorite by addition of demineralised water. 145 ml of this dilute dispersion are stored in a flat glass trough (19.4×19.4 cm) in a calm place at RT until the dispersion has dried completely. Although the resulting film having a solids content of 100 wt. % can easily be detached in one piece, a self-adhesive polypropylene film (Herma) is applied over the surface as carrier material in order to prevent mechanical damage. The 2-layer composite is removed from the glass trough and the oxygen barrier of the material is tested. The pure polypropylene film is measured as reference.

Measurement of the oxygen transmission of the PP film gave a value of 2097.9 cm²/m²·d·bar (arithmetic normalisation to 100 μm film thickness: 1335.64 cm²/m²·d·bar).

Measurement of the oxygen transmission of the 2-layer composite Li hectorite/PP film gave a value of 7.3-9.8 cm²/m²·d·bar with a film thickness of the Li hectorite of 6.5-15.1 μm (arithmetic normalisation to 100 μm film thickness: 0.98 cm²/m²·d·bar).

### Comparison Example 1

### Barrier Properties of a Film of Na Montmorillonite

500 mg of Na montmorillonite (Cloisite Na+) are added to 150 ml of demineralised water and stirred for 1 day. The montmorillonite dispersion is then poured into a flat glass trough (19.4×19.4 cm) and stored in a calm place at RT until the dispersion has dried completely. The resulting film having a solids content of 100 wt. % can be detached from the glass surface less well than the Li hectorite in Example 2. By using a self-adhesive PP film as support material, suitable samples for the O₂ barrier measurement are prepared.

Measurement of the oxygen transmission of the 2-layer composite Na montmorillonite/PP film gave a value of 145.7-169.1 cm²/m²·d·bar with a film thickness of the montmorillonite film of 6.7-7.8 μm (arithmetic normalisation to 100 μm film thickness: 48.5 cm²/m²·d·bar).

### Comparison Example 2

### Barrier Properties of a Film of Hydrothermally Synthesised Hectorite (Optigel SH)

The hectorite of the Optigel SH type that is used is a commercial product which was prepared by hydrothermal synthesis, as a result of which the platelet diameter is limited to 50 nanometres on average. Optigel SH delaminates spontaneously in water. 500 mg of the dry hectorite of the Optigel type are added to 150 ml of demineralised water and stirred for 1 day. The colloidal solution is then shaken into a flat glass trough (19.4×19.4 cm) and stored in a calm place at RT until the dispersion has dried completely. The resulting transparent film cannot be detached from the trough and accordingly cannot be tested in respect of its barrier properties.

Although an alternative preparation method, in which the same aqueous dispersion of Optigel SH was dried directly on the polypropylene substrate, led to a homogeneous film, it was likewise not possible to measure the O₂ barrier owing to the brittleness of the film and the resulting mechanical damage by cracking.

### Discussion of the Properties

The phyllosilicate of the Li hectorite type in Example 1 has very large platelet diameters, which are far above those of natural and hydrothermally prepared smectites and are approximately in the range of the vermiculites. The swelling properties are more pronounced as compared with natural phyllosilicates, for example vermiculites and montmorillonites. This manifests itself in the spontaneous exfoliation of the Li hectorite of Example 1 in suitable solvents, such as, for example, water. The result are flexible phyllosilicate platelets or lamellae according to the invention, which have extremely large aspect ratios >>400. It has not hitherto been possible to produce materials having such high aspect ratios economically and with a low content of crystalline impurities. The superior properties of this material are particularly prominent in gas barrier measurements, where the drastic reduction in the O₂ permeability from 2097.9 cm²/m²·d·bar to 8.6 cm²/m²·d·bar on average was demonstrated by applying a thin Li hectorite film (average thickness 10.8 μm) to a PP substrate.

It should be noted that no chemical or physical pretreatment of any kind is necessary in order to achieve these results.

The comparison with conventional phyllosilicates, for example natural montmorillonite or commercial, hydrothermally synthesised hectorite, clearly shows the superiority of the phyllosilicate according to the invention.

By the described synthesis there is additionally provided a scalable process by means of which the phyllosilicates according to the invention can be produced in high purity from simple basic chemicals in a short time. This represents a significant increase in efficiency as compared with lengthy hydrothermal methods.

1-12. (canceled)

13. Process for the production of phyllosilicate platelets having a high aspect ratio, comprising preparing
A) a synthetic smectite of the formula
[M_{n/valency}]^{inter} [M^{I}ₘM^{II}ₒ]^{oct} [M^{III}₄]^{tet} X₁₀Y₂
in which
M are metal cations of oxidation state 1 to 3,
M^{I} are Metal cations of oxidation state 2 or 3,
M^{II} are metal cations of oxidation state 1 or 2,
M^{III} are atoms of oxidation state 4,
X are di-anions and
Y are mono-anions,
m for metal atoms M^{I} of oxidation state 3 is ≦2.0 and for metal atoms M^{I} of oxidation state 2 is ≦3.0,
o is ≦1.0 and
the layer charge n is >0.8 and ≦1.0,
by high-temperature melt synthesis and
B) exfoliating and/or delaminating the synthetic smectite prepared in step A) to give phyllosilicate platelets having a high aspect ratio.

14. The process of claim 13, wherein M is Li+, Na+, Mg2+ or a mixture of two or more of those ions, MI is Mg2+, Al3+, Fe2+, Fe3+ or a mixture of two or more of those ions, MII is Li+, Mg2+ or a mixture of those ions, MIII is a tetravalent silicon cation, X is O2—and Y is OH— or F—.

15. The process of claim 13, wherein M is Li+.

16. The process of claim 13, wherein the layer charge n is ≧0.85 and ≦0.95.

17. The process of claim 13, wherein the high-temperature melt synthesis is carried out in an open crucible system.

18. The process of claim 17, wherein, for the production of the synthetic smectite, a glass stage of the general composition wSiO2.xMa.yMb.zMc is used, wherein 5<w<7; 0<x<4; 0≦y<2; 0≦z<1.5 and Ma, Mb, Mc are metal oxides and Ma is other than Mb is other than Mc.

19. The process of claim 13, wherein in step B) the synthetic smectite is introduced into a polar solvent in order to exfoliate or delaminate it.

20. The process of claim 13, wherein in step B) water, water-miscible solvents, dilute aqueous acids or bases and/or mixtures thereof are used as the polar solvent.

21. Phyllosilicate platelets prepared by the process of claim 13.

22. A flameproof barrier or a diffusion barrier comprising the phyllosilicate platelets of claim 21.

23. A composite material comprising the phyllosilicate platelets of claim 21.

24. The composite material of claim 23, wherein said composite material comprises a polymer.
